(19) United States
(12) Patent Application Publication
(10) Pub. No.: US 2016/0058036 A1
(43) Pub. Date: Mar. 3, 2016

(54) Plant and method for manufacturing long-fiber feed pellets for zootechnical use

(71) Applicants: Tommaso VIANELLO DRI, Teolo (VI) (IT); Riccardo BISAZZA, Vicenza (IT)

(72) Inventors: Tommaso Vianello Dri, Teolo (PD) (IT); Riccardo Bisazza, Vicenza (IT)

(21) Appl. No.: 14/779,074

(22) PCT Filed: Dec. 12, 2014
(86) PCT No.: PCT/IB2014/066859

§ 371 Date: Sep. 22, 2015

(30) Foreign Application Priority Data
Dec. 12, 2013 (IT) VI2013A000293
Dec. 12, 2013 (IT) VI2013A000294

(51) Int. Cl. A23K 1/14; A23N 17/00; A23K 3/00; A23K 1/00

(52) U.S. Cl. CPC A23K 1/14; A23K 1/003; A23N 17/005; A23K 3/00; A23N 17/007

(57) ABSTRACT

A plant for manufacturing long-fiber legume hay and grass hay-based feed pellets for zootechnical use includes a loading station loading predetermined amounts of the hays, a processing station processing the hays to reduce fiber length to a predetermined average value, a mixing station mixing the reduced hays with predetermined amounts of binders and nutritional additives to obtain a dough, a forming station forming the dough which has a collection chamber, a forming die communicating with the collection chamber, and an extrusion passage, a pushing element, held within the collection chamber and feeding the dough toward said passage, an extruder downstream of the pushing element and moving in the collection chamber to cyclically push predetermined amounts of dough into the passage and form a stratified bead of dough, and a breaking system for breaking the bead forming stratified feed pellets. A method of manufacturing long-fiber feed pellets for zootechnical use.

### FIELD OF THE INVENTION

The present invention generally finds application in the field of animal feeds and particularly relates to a plant for manufacturing long-fiber feed pellets for zootechnical use.

The invention also relates to a method of manufacturing long-fiber feed pellets for zootechnical use.

### BACKGROUND ART

In the field of animal feeds, there has been known to use fodders comprising a mixture of legume hays, grass hays and other vegetable or animal fibers.

Such fodders may be supplemented with additives, such as vitamins, mineral salts, proteins or the like, in view of increasing their nutritional value and ensure that the animal achieves its proper caloric intake.

The final product so obtained, comprising both hays and additives, is generally known as Total Mixed Ration (TMR).

One drawback of prior art compound feed products is that they are often affected by sedimentation of hays or other components, due to uneven mixing thereof as the mixture is being formed.

Furthermore, such uneven mixture composition causes a substantially stratified arrangement of the feed components in the feed bag, which has detrimental effects when the feed is administered to a plurality of animals of the farm.

The horses fed with portions of the feed that come from the top of the bag may receive nutritional components other than those received by horses fed with portions of the same feed product that come from the bottom of the bag.

In view of obviating such drawbacks, forage-based feeds have been developed which comprise fodder mixtures composed of fibers of variable length, which are compressed to form elements of various shapes and sizes, commonly known as “pellets”.

For example, U.S. Pat. No. 8,273,400 discloses a method and a plant for making compacted forage-based feeds for horses, which comprises a mixing step, in which hays are mixed with various additives and thickeners and a later extrusion step, aimed at forming a compact consumable finished product.

The plant comprises a plurality of processing stations, which will reduce the initial length of hays and create long-fiber forage-based pellets having an adequate consistency to remain intact until consumption by an animal.

Furthermore, the presence of long fibers in the structure of these feeds has beneficial effects on the nutrition of such animals, as they directly act on their digestive system to improve the digestive process.

Nevertheless, a first drawback of this plant and method is that the feeds provided thereby have a variable moisture content, which changes their consistency and often makes them too dry and hard or too wet and soft.

Furthermore, such excessively high or low moisture content hinders the feed forming process and causes the horse to have a reduced caloric intake from the feed.

A further drawback of these forage-based feeds is that the pellets formed by the extrusion station are likely to be too compact, and hence hard to chew and digest by the animal.

Namely, such excessive compaction of the feed may cause the pellets to swell in the stomach of the animal and even cause dangerous occlusions thereof.

Furthermore, the plant includes a station in which the mixture is cut and ground to provide a compound in which the base components cannot be visually distinguished.

Such structure of the compound affects the recognizability of the feed product by the farmer.

Another important drawback of this plant and method is that the cutting station generates a considerable amount of offcuts, which may add to the mixture, thereby reducing the compaction of the finished feed product structure.

WO2008/063347, GB2159689, DE3233121 and U.S. Pat. No. 2,995,445 disclose systems and/or apparatus for manufacturing extruded stratified feed pellets for zootechnical use, which contain all the features as defined in the preamble of the independent claim.

Nevertheless, these system and apparatus have the drawback of excessively heating the dough for making the feed pellets, as it is being conveyed and extruded.

### DISCLOSURE OF THE INVENTION

The object of the present invention is to overcome the above drawbacks, by providing a plant and a method for manufacturing long-fiber feed pellets for zootechnical use, that are highly efficient and relatively cost-effective.

A particular object of the present invention is to provide a plant and a method for manufacturing long-fiber feed pellets for zootechnical use, that allow manufacture of feed pellets having a homogeneous, even composition of the base components.

A further object of the present invention is to provide a plant and a method for manufacturing long-fiber feed pellets for zootechnical use, that allow manufacture of pellets having regular shapes, particularly suitable for consumption by animals.

Another object of the present invention is to provide a plant and a method for manufacturing long-fiber feed pellets for zootechnical use, providing pellets that can be easily chewed and digested by animals.

Yet another object of the present invention is to provide a plant and a method for manufacturing long-fiber feed pellets for zootechnical use, that can adjust the consistency of pellets to increase chewing time.

A further object of the present invention is to provide a plant and a method for manufacturing long-fiber feed pellets for zootechnical use, that allow manufacture of pellets having a well-defined composition of their base components.

Another object of the present invention is to provide a plant and a method for manufacturing long-fiber feed pellets for zootechnical use, providing low-microbial load and high shelf-life pellets.

Yet another object of the present invention is to provide a plant and a method for manufacturing long-fiber feed pellets for zootechnical use, that allows the various base components mixed therein to be distinguishable.

These and other objects, as more clearly explained hereafter, are fulfilled by a plant for manufacturing long-fiber feed pellets for zootechnical use, as defined in claim 1.

In another aspect, the invention provides a method of manufacturing long-fiber feed pellets for zootechnical use, as defined in claim 13.

Advantageous embodiments of the invention are obtained as defined in the dependent claims.

### BRIEF DESCRIPTION OF THE DRAWINGS

Further features and advantages of the invention will be more readily apparent upon reading of the detailed description of a few preferred, non-exclusive embodiment of a plant and a method for manufacturing long-fiber feed pellets for zootechnical use according to the invention, which are shown as non-limiting examples with the help of the annexed drawings, in which:

FIG. 1 is a schematic block diagram of a plant of the invention according to a first configuration;

FIG. 2 is a schematic block diagram of a plant of the invention according to a second configuration;

FIG. 3 is a lateral sectional view of a first detail of FIG. 1 and FIG. 2, as taken along the plane III-III;

FIG. 4 is an enlarged sectional view of a second detail of FIG. 3;

FIG. 5 is an enlarged view of a third detail of FIG. 4;

FIG. 6 shows the third detail of FIG. 5 at three different operating times;

FIG. 7 is a front sectional view of a second detail of FIG. 5, as taken along the plane XII-XII;

FIG. 8 is a first base block diagram of a method of manufacturing long-fiber feed pellets for zootechnical use according to the invention;

FIG. 9 is a second block diagram of the method of FIG. 8.

### DETAILED DESCRIPTION OF A PREFERRED EMBODIMENT

The above figures show a plant for manufacturing long-fiber feed pellets C for zootechnical use, generally designated by numeral 1, and preferably formed from legume hays and grass hays F, F′.

Particularly, the plant 1 of the invention may be used to make feed pellets C for zootechnical use that contain, in addition to legume and grass hays F, F′, additional vegetable and/or animal fibers, not shown.

Advantageously, the plant 1 may be designed to manufacture feed pellets C that are used for feeding both pets and livestock.

For example, the feed pellets C obtained using this plant 1 may be used as forage for horses, donkeys, mules, hinnies or the like, or may be designed for feeding pets such as dogs, cats, rabbits or the like.

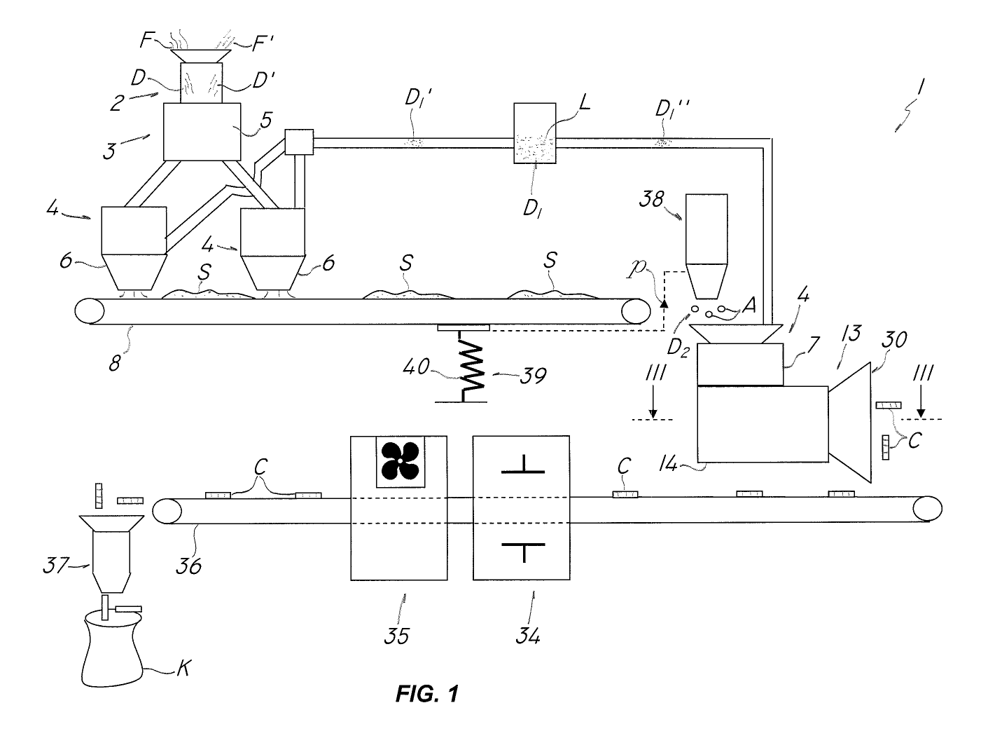

In its basic form, as shown in FIG. 1, the plant 1 of the invention comprises loading means 2 for loading predetermined amounts D, D′ of the hays F, F′, and processing means 3 for promoting reduction of the length l of the fibers of the hays F, F′ to a predetermined average value I_{M}.

The processing means 3 may be designed to promote reduction of fiber length l to an average value I_{M} close to about 5 cm.

The plant 1 further comprises mixing means 4 for mixing hays F, F′ reduced by the processing means 3 with predetermined amounts D₁, D₂ of a binder L and nutritional additives A to obtain a dough I.

Preferably, the mixing means 4 may be designed to mix the fibers of the hays F, F′ with a single binder L selected from the group comprising aqueous molasses.

Furthermore, the binder L that is used in the plant may be of the single-component type, or may be obtained by joining various components.

Furthermore, the mixing means 4 may be designed to mix the fibers with nutritional additives A comprising vitamins and/or mineral salts and/or cereals.

Conveniently, the mixing means 4 may be adapted to mix the fibers of the hays F, F′ with a total weight percent D₁ of binder L ranging from 3% to 20% based on the total weight of the dough I.

Preferably, the loading means 2 may comprise a substantially vertical loading chamber, not shown, which is designed to collect the amounts D, D′ of the legume and grass hays F, F′ that have been introduced into the plant 1.

In a first configuration of the plant, as shown in FIG. 1, the processing means 3 may comprise at least one cutting station 5, for reducing the length l of the fibers to the predetermined average value I_{M}.

Preferably, the cutting station 5 may comprise a helically shaped element, not shown, which is located within the loading chamber and is capable of rotating about a vertical axis of rotation, also not shown.

This helically shaped element may have a cutting edge to promote cutting of the hays F, F′ that have been introduced into the loading chamber, thereby reducing the length l of the fibers to the predetermined average value I_{M}.

The mixing means 4 may comprise at least one first mixing station 6, which is located downstream from the cutting station 5 to mix the reduced fibers with a predetermined amount D₁ of binder L to obtain an amalgamated semifinished product S.

In the plant configuration as shown in FIG. 1, first mixing stations 6 are provided, each adapted to receive a portion of the reduced fibers from the cutting station 5, to mix them with the binder L.

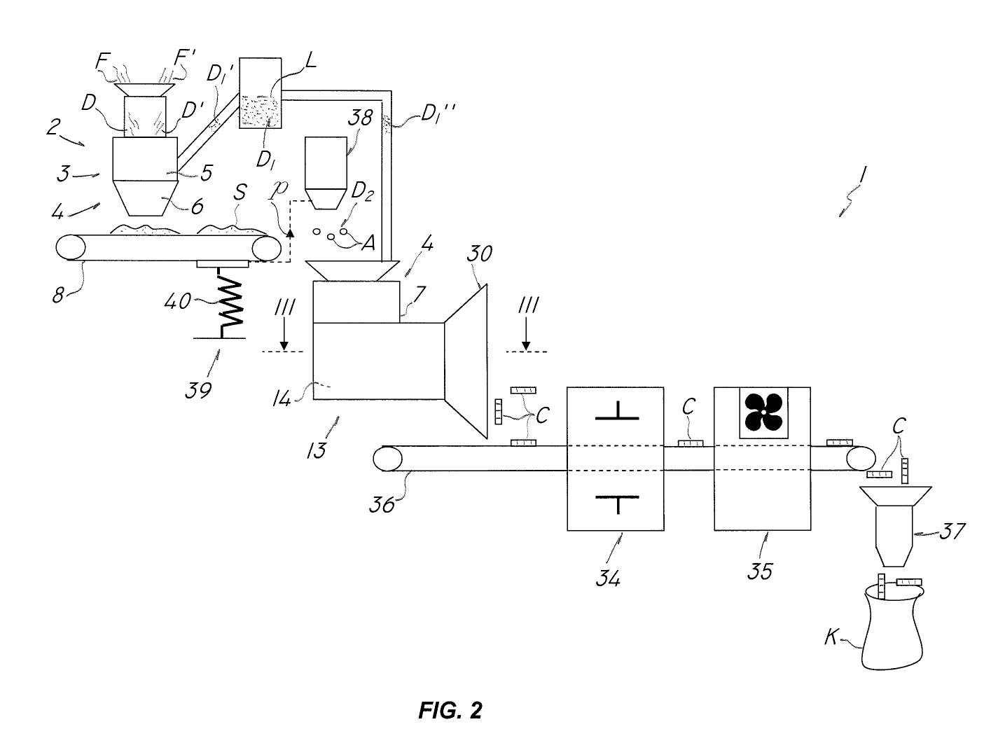

Furthermore, in an alternative configuration of the invention as shown in FIG. 2, the cutting station 5 and the first mixing station 6 may be both arranged within the loading chamber, not shown, such that the fibers of the hays F, F′ may have their length l reduced and be mixed with the binder L at the same time.

Conveniently, the mixing means 4 may comprise at least one second mixing station 7 downstream from the first mixing station 6, to mix the amalgamated semifinished product S with the nutritional additives A, thereby obtaining the dough I.

A first conveyor belt 8 may be provided between the first mixing stations 6 and the second mixing station 7.

The mixing means 4 may be further designed to introduce the total amount D₁ of binder L in to the first mixing stations 6.

Alternatively, as best shown in FIGS. 1 and 2, the mixing means 4 may be adapted to introduce a first amount D₁′ of binder L into the first mixing stations 6 and the remaining amount D₁″ of binder L into the second mixing station 7.

By changing the remaining amount D₁″ of binder introduced into the second mixing station 7, the moisture content of the dough I may be adjusted.

Thus, the sum of the first D₁′ and second D₁″ amounts of binder will be equal to the predetermined amount (D₁=D₁′+D₁″) of binder L required to be mixed to the hays F, F′. Particularly, the mixing means 4 may be adapted to change the amount D₁″ of binder L provided to the second mixing station 7, such that a dough I with a predetermined moisture content ranging from 10% to 15% based on its total weight may be obtained at its output.

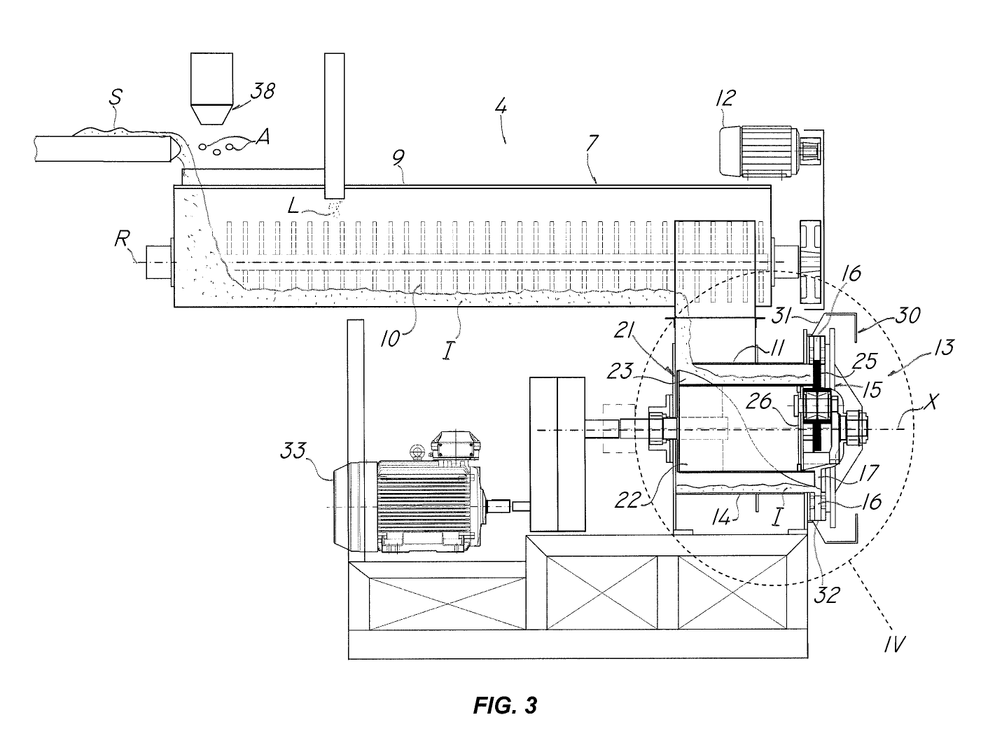

Preferably, as best shown in FIG. 3, the second mixing station 7 may comprise a tubular container 9 which houses a screw 10 with a substantially horizontal axis of rotation R, to promote mixing and feeding of the semifinished product S with the additives A toward an outlet 11.

The second mixing station 7 may comprise first motor means 12 for promoting rotation of the screw 10 about its axis of rotation R.

The plant 1 also comprises forming means, generally referenced 13, to form feed pellets from the dough I.

In the illustrated embodiment, the forming means 13 comprise a collection chamber 14, which communicates with the second mixing station 7 via the outlet 11 of the dough I, and an extrusion die 15 which communicates with a collection chamber 14 and has one or more extrusion passages 16.

The extrusion die 15 may be placed at the distal end 14′ of the collection chamber 14 and may comprise a substantially annular gap 17 coaxial with the collection chamber 14. In the illustrated embodiment, the gap 17 is created by a pair of substantially parallel and facing annular plates 18, 19, which are coupled together by a peripheral element 20 having a predetermined thickness, to change the width w₁ of the gap 17 between predetermined minimum and maximum values.

For example, the width w₁ of the gap 17 may range from 2 cm to 8 cm and, if the plant 1 is designed to manufacture equine feeds, such width w₁ maybe set to a value close to about 4 cm.

In the illustrated embodiment, the collection chamber 14 has a substantially cylindrical shape with a preferably horizontal first longitudinal axis X, and accommodates therein a feeding member 21 in the form of a screw, which is adapted to rotate about an axis coinciding with the first longitudinally axis X to promote feeding of the dough I toward the extrusion passage/s 16.

In the illustrated embodiment, the feeding member 21 consists of a cylindrical core 22 having a helical driving screw 23 welded thereon.

For example, the axial length w₃ of the helical driving screw 23 may be greater than the length w₄ of the cylindrical core 22 such that its end 24 is placed at a distance d₁ from the extrusion die 15 that is substantially equal to the width w₁ of the gap 17.

Furthermore, the feeding member 21 may be adapted to promote movement of the dough I toward the extrusion die 15 and progressive compaction thereof at the gap 17. In the illustrated embodiment, the die 15 comprises a plurality of substantially radial and angularly staggered extrusion passages 16

Thus, the forming means 10 may promote simultaneous forming of one or more beads B of stratified dough I.

Furthermore, the die 15 may comprise heating means, not shown, which are adapted to heat the passages 16 to assist the sliding motion of the bead B therein.

The forming means 13 further comprise a pusher element 25, which is supported at the downstream end 26 of the feeding member 21 and is adapted to cyclically push a predetermined amount of dough I through the extrusion passage/s 16 to extrude respective beads B composed of compact layers H of dough I.

Preferably, each extrusion passage 16 may have a predetermined sectional shape, such as a triangular, square, rectangular, polygonal, circular, elliptical shape or any mixed profile.

Preferably, the pusher element 25 may be substantially disk-shaped with a central hub 27 and a circular peripheral portion 28, and is rotatably supported at the downstream end 26 of the cylindrical core 22 to freely rotate about a second axis X′, which is substantially parallel to the first longitudinal axis X and at a radial distance d₂ therefrom.

Therefore, the rotation of the feeding member 21, i.e. its cylindrical core 22, about the first axis X will cause the rotation of the pusher element 25, which will in turn revolve about the second axis X′, the latter being eccentric with respect to the first axis X, such that at every turn about the axis X it can push a layer H of dough I into the extrusion passage 16 and form the stratified beads B.

Conveniently, the pusher element 25 may freely rotate with a predetermined clearance in the gap 17 in which the dough I is collected, to thereby reduce the friction between its circular peripheral portion 28 and the walls 29 of the gap 17 as it rotates about the second axis of revolution X′.

Due to this reduced friction, the dough I will not increase its temperature as its layers H are pushed through, and the properties of the dough I will not be altered.

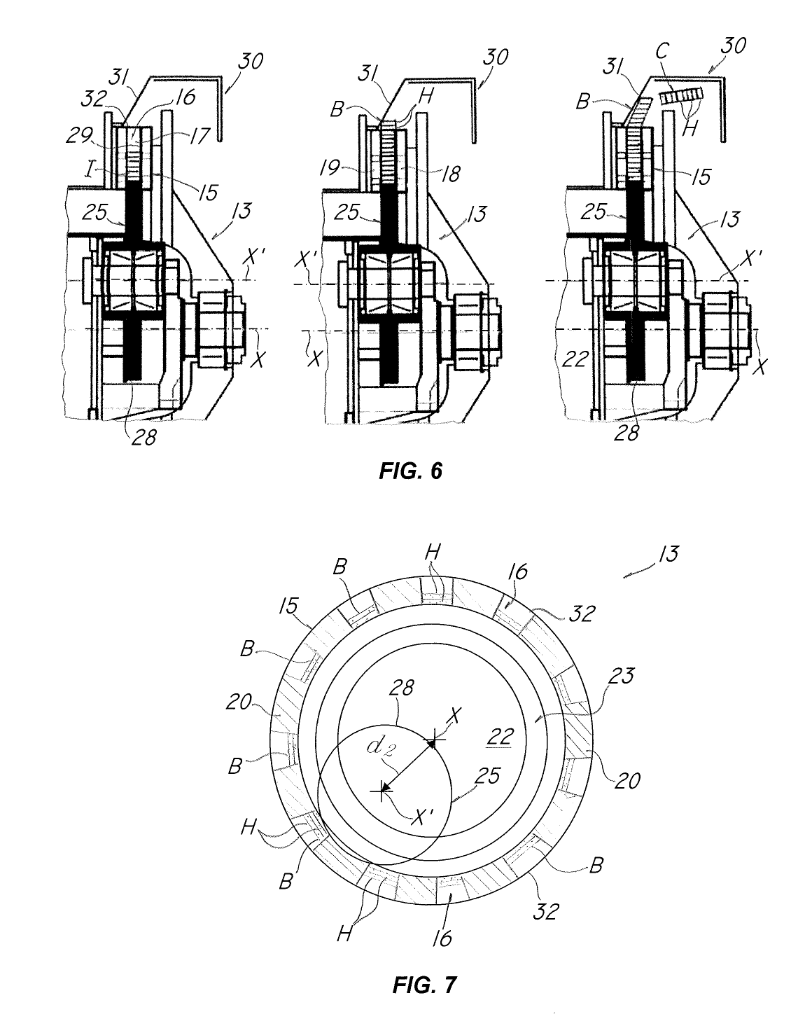

In the illustrated embodiment, the plant 1 comprises breaking means 30 having a substantially frustoconical wall located at the periphery of the extrusion passages 16 to interfere with each stratified bead B and cause it to be periodically broken to form the feed pellets C, as shown in the sequence of FIG. 6.

Preferably, as shown in FIG. 5, the distance d₃ between the frustoconical wall 31 and the outlet hole 32 of the extrusion hole 16 may be changed according to the desired length of the pellets C. Preferably, the distance d₃ may be selected to promote breaking of the bead into feed pellets C whose average length ranges from about 2 cm to 10 cm and is preferably close to about 4 cm.

Thus, each pellet C will be composed of a number of layers H ranging from 4 to 20, and preferably close to 8.

Indeed, a feed pellet C of such average size was found to be more easily digested by the animal, especially if such animal is an equine or another monogastric animal. Furthermore, the nutritional properties of the feed pellet C are compliant with the requirements for proper growth of the animal, with relatively crumbly pellet layers for easier chewing and digestion by the animal.

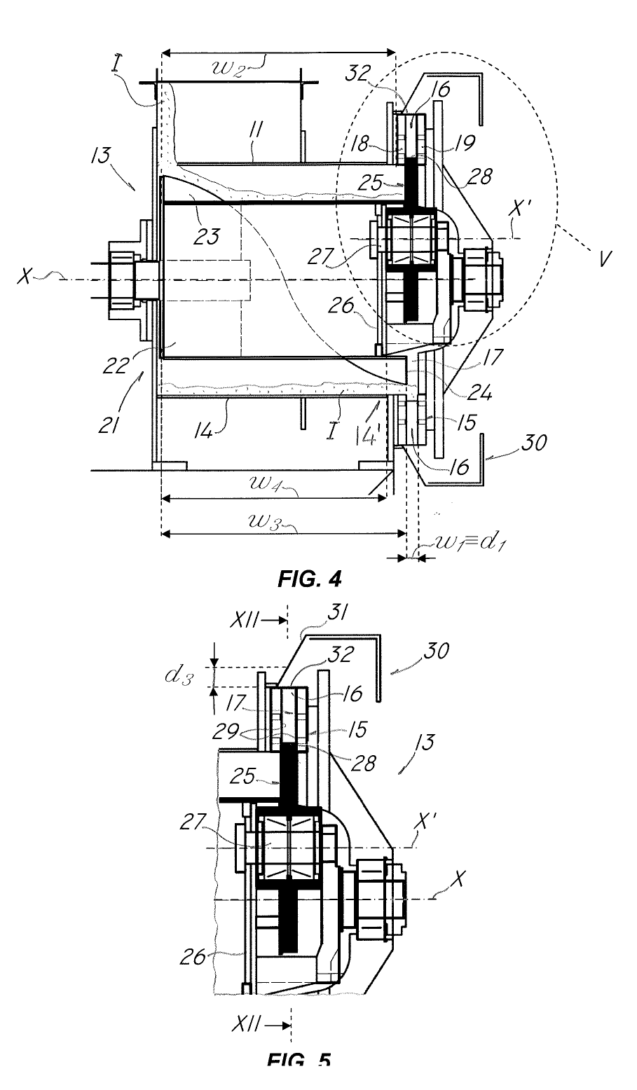

Particularly, in the plant as shown in FIGS. 3 to 7, the pusher element 25 may be designed to promote pushing of a layer H as thick as about 0.5 cm into the extrusion passages 16.

Conveniently, as shown in FIG. 3, the forming means 13 may comprise second motor means 33 for promoting rotation of the feeding member 21 and the pusher element 25 about the first longitudinal axis X, as well as revolution of the same pusher element 25 about the second axis X′ by interaction with the inner walls 29 of the gap 17 and with the dough I.

Conveniently, as best shown in FIGS. 1 and 2, the plant 1 may comprise a sanitizing station 34, downstream from the forming station 10, for reducing the microbial load in the feed pellets C below a predetermined threshold value.

The sanitizing station 34 will afford reduction or total elimination of any bacterial colony that may cause infections to the digestive system of the animal.

Particularly, the sanitizing station 34 may comprise means for application of an alternating electromagnetic field, not shown, having a predetermined frequency selected from the radio-frequency and microwave band.

For example, if the sanitizing means generate a radio-frequency electromagnetic field, then frequency may range from 3 MHz to 3 GHz whereas if the sanitizing means generates a microwave electromagnetic field, then frequency may range from 3 GHz to 100 GHz.

Furthermore, application of an electromagnetic field having a predetermined frequency will afford a reduction of the microbial load of the feed pellets C without causing it to be heated beyond the threshold value.

Conveniently, as best shown in FIGS. 1 and 2, downstream from the sanitizing station 34, the plant 1 may comprise at least one cooling station 35, for instance having a chamber with a cold air stream flowing therethrough, located downstream from the forming station 13 to promote cooling of the feed pellets C to a predetermined temperature close to ambient temperature.

Alternatively, according to an alternative configuration of the invention which is not shown in the figures, the plant 1 may comprise a single station downstream from the forming means 13, providing both sanitization and cooling of the pellets.

Furthermore, at least one second belt 36 may be provided downstream from the first belt 8, for conveying pellets C through the sanitizing station 34 and the cooling station 35.

Conveniently, a packaging station 37 may be provided at the end of the second belt 36, for picking up loose pellets C from the cooling station 35 and package them into bags K and/or containers having a predetermined weight or volume.

The plant 1 may also comprise dosing means 38, for metered addition of nutritional additives A to the semifinished product S obtained in the first mixing stations 6, as shown in FIGS. 1 and 2.

Furthermore, the dosing means 38 may be located upstream from the forming means 13 and may be designed to add calibrated doses D₂ of nutritional additives A to the semifinished product S in the second mixing station 7.

The plant 1 may comprise weighing means 39, for weighing the semifinished product S, and the dosing means 38 may be adapted to change the doses D₂ of nutritional additives A according to the instantaneous weight of the semifinished product as detected by the weighing station 39.

The weighing means 39, as clearly shown in the figures, may comprise an electronic scale 40 associated with a portion of the first belt 8 and adapted to continuously weigh the semifinished product S conveyed thereby, and to transmit an electric signal p varying according to the detected weight.

The electric signal p will be transmitted to the dosing means 38 to allow the latter to change the doses D₂ of nutritional additives A to be delivered to the second mixing station 7 according to the weight of the semifinished product S.

In a further aspect, the invention relates to a method of manufacturing long-fiber feed pellets C for zootechnical use.

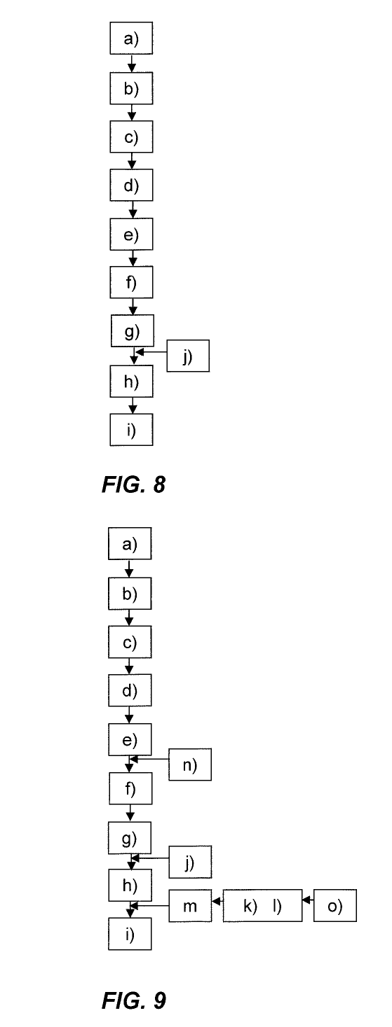

As best shown in the block diagram of FIG. 8, the method of the invention comprises a first step a) of selecting various types of hays F, F′, obtained from legumes and grass, alfalfa, which may be also added with different vegetable and animal fibers.

In the next step b), predetermined amounts of hay types F, F′ are mixed to obtain a fibrous mixture, with possible removal of heavy solid bodies from the bales.

Preferably, in step b), mixing amounts may be 5% to 50% legume hay types F, based on the total weight and 50% to 95% grass hat types F′, based on the total weight.

After the mixing step b) a step c) is provided, in which the fibrous mixture is cut to obtain a long-fiber forage base, with fibers having an average length from 3 cm to 10 cm, preferably from 5 cm to 6 cm.

A step d) follows, in which a predetermined amount of one or more binders L is added, which is adsorbed by the fibers of the forage base to stabilize its dimensions, and in a later step e) the forage base and the binders L are mixed to obtain a semifinished product S.

Preferably, the steps c), d) and e) may be carried out at the same time, such that a first predetermined amount of binder L is added to and mixed with the hays F, F′, as soon as the latter are being cut.

A further step f) may be provided, in which one or more nutritional additives A are added to the semifinished product S, and a step g) may follow, in which these additives are mixed with the semifinished product S to obtain a dough I.

The addition of nutritional additives A to the semifinished product S, said additives being selected from the group comprising vitamins and/or mineral salts and/or cereals, will provide a dough I that can be used to form a long-fiber feed pellet C whose nutritional properties meet the requirements for proper growth of the animal.

Downstream from the mixing step g), a step h) is provided, in which the dough I is formed into predeterminedly shaped feed pellets C for consumption by the animal.

The forming step h) will be followed by a packaging step i) in which the feed pellets C will be packaged into bags of predetermined size and weight.

According to a peculiar characteristic of the method, upstream from the forming step h), a step j) is provided in which the moisture content of the dough I is automatically adjusted for improved processability.

It shall be noted that the forming step h) may include extrusion of the dough I through the extrusion passages 16 located at the periphery of the gap 17 of the extrusion die 15 as a result of the thrust exerted by the idly rotating pusher element 25 mounted at the downstream end 26 of the cylindrical core 22. Due to the rotation of the core 22 in the collection chamber 14 about the first axis of rotation X, the pusher element 25 will cooperate with the inner walls 29 of the gap 17, thereby revolving about the second axis X′, which is parallel and eccentric with respect to the first axis X, and actually pressing the dough I out of the gap 17 through the extrusion passages 16.

Thus, at each complete turn of the cylindrical core 22, the pusher element 25 will form a layer H of dough that will add to the previous layers to form a plurality of beads B of dough I at the passages 16 and their outlet holes 32. Due to the interaction with the frustoconical walls 31 of the breaking means 30, the beads B will break into wafer-like stratified feed pellets C, that can be easily chewed and crumbled by the animal.

The adjustment of the moisture content of the dough I and its stratification as it is being formed will provide pellets C with regular and stable shapes, and with a relatively soft consistency for easier chewing and digestion by the animal.

Conveniently, the adjustment step j) may be designed to maintain the moisture content of the dough I in a range from 5% to 40% based on its total weight.

The dough I has been experimentally found to exhibit optimized processability when its moisture content ranges from 10% to 15%, based on its total weight.

The forming step h) may be designed to obtain wafer-like pellets whose plan shape is selected from square, rectangular, polygonal, circular, elliptical or the like shapes.

Based on a number of tests on equines the rectangular plan shape of the stratified wafer was surprisingly found to further facilitate chewing and assimilation of the feed by the animal.

[00115]The diagram of FIG. 9 shows a variant of the method of FIG. 8, which differs from the former in that it comprises a further step k) in which the wafers produced during the forming step h) are sanitized to reduce their microbial and sporal load, as well as molds and yeasts to extend the shelf life of the feed.

Particularly, the sanitizing step k) may be carried out through a step I) in which an electromagnetic field having a predetermined frequency is applied to the pellets C, followed by a first pellet cooling step m).

The electromagnetic field application step l) will reduce the microbial and sporal load in the wafer whereas the first cooling step m) will prevent the initiation of fermentation processes which would form molds or yeasts.

Furthermore, the method differs in that it comprises an additional step n) in which the semifinished product S is weighed such that in step f) the amount of nutritional additives A to be added may be adjusted according to the weight of the semifinished product S as detected in stem n), as well as a second cooling step o) for cooling the pellets C.

The second cooling step o) will prevent the temperature of the pellets C from exceeding a predetermined threshold value, such that the later sanitizing step k) will not be affected.

The invention is susceptible of many changes and variants within the inventive principle disclosed in the annexed claims. All the details thereof may be replaced by other technically equivalent parts, and the materials may vary depending on different needs, without departure from the scope of the invention.

While the plant and method have been described with particular reference to the annexed figures, the reference numerals are only used for the sake of a better intelligibility of the invention and shall not be intended to limit the claimed scope in any manner.

### INDUSTRIAL APPLICABILITY

The present invention finds industrial application in the zootechnical field and particularly in plants and method for manufacturing feeds for ruminant and monogastric animals.

The invention claimed is:

1. A plant for manufacturing long-fiber feed pellets (C) based on legume hay (F) and grass hay (F′) for zootechnical use, the plant comprising:
a loading station (2) loading predetermined amounts (D, D′) of the hays (F, F′);
a processing station (3) processing the hays (F, F′) and designed to reduce lengths (l) of fibers to a predetermined average value (I_{M});
a mixing station (4) mixing the hays (F, F′) with predetermined amounts (D₁=D₁′+D₁″; D₂) of binders (L) and nutritional additives (A) to obtain a dough (I);
a forming station (13) forming said dough (I), said forming station having a substantially cylindrical collection chamber (14) with a first longitudinal axis (X);
an extrusion die (15) communicating with the collection chamber (14) and having at least one extrusion passage (16);
a feeding member (21), which is rotatably housed in said collection chamber (14) to rotate about said first axis (X) and feeding of said dough (I) toward said at least one passage (15) in a longitudinal axial direction;
a pusher element (25) located downstream of said feeding member (21) and rotatable within said collection chamber (14) to cyclically push a predetermined amount (H) of said dough (I) through said at least one passage and form a stratified bead (B) of said dough (I);
a breaking station (30) where said bead (B) is broken, located downstream from said at least one passage (16) to form stratified feed pellets (C);
wherein said die (15) comprises a substantially annular gap (17), which is located at the distal end (14′) of said chamber (14) in communication therewith, said gap (17) having at its periphery said at least one substantially radial extrusion passage (16), said pusher element (25) substantially having a disk shape and being rotatably mounted, to rotate about a second revolution axis (X′), which is substantially parallel and eccentric with respect to the first axis (X), said pusher element (25) being inserted in said gap (17) to radially push outwards, at each turn about said first longitudinal axis (X), a layer (H) of dough (I) into said at least one extrusion passage (16).

2. The plant as claimed in claim 1, wherein said feeding member (21) comprises a cylindrical core (22) having a helical driving screw (23) fixed thereto, whose axial length (w₃) is not smaller than the axial length (w₄) of said core (22).

3. The plant as claimed in claim 2, wherein said disk-shaped pusher element (25) is mounted in an idly rotatable manner at the downstream end (26) of said cylindrical core (22) to rotate about said second revolution axis (X′).

4. The plant as claimed in claim 1, wherein said die (15) comprises a plurality of substantially radial and angularly staggered extrusion passages (16), said disk-shaped pusher element (25) having a circular peripheral portion (28) whose size allows it to fit into said gap (17) with a small clearance as it rotates and create a substantial sealing effect therewith.

5. The plant as claimed in claim 1, wherein said breaking station (30) comprises a substantially frustoconical wall (31) located at a periphery of and external to said at least one passage (16) to interfere with the stratified bead (B) and cause it to be periodically broken to form the feed pellets (C).

6. The plant as claimed in claim 1, further comprising a sanitizing station (34) located downstream of said forming station (13) to reduce the microbial load in said feed pellets (C) below a predetermined threshold value.

7. The plant as claimed in claim 6, wherein said sanitizing station (34) comprises means for application of an alternating electromagnetic field having a predetermined frequency selected from the range of frequencies from 3 MHz to 100 GHz.

8. The plant as claimed in claim 1, further comprising at least one cooling station (35) located downstream of said forming station (13) to promote cooling of said feed pellets (C) to a predetermined temperature proximate to ambient temperature.

9. The plant as claimed in claim 1, wherein said processing station (3) comprises at least one cutting station (5), for reducing a length (l) of the fibers to said predetermined average value (I_{M}).

10. The plant as claimed in claim 9, wherein said mixing station (4) comprises at least one first mixing station (6), which is located downstream from said at least one cutting station (5) to mix the cut fibers with a first predetermined amount (D₁) of binder (L) to obtain an amalgamated semifinished product (S).

11. The plant as claimed in claim 10, wherein said mixing station (4) comprises a first and a second mixing station (7), the second mixing station being located downstream of said first mixing station (6), and adapted to mix said amalgamated semifinished product (S) with said predetermined amount (D₂) of nutritional additives (A) and with the remaining amount (D₁″) of binder (L) to obtain said dough (I).

12. The plant as claimed in claim 10, further comprising continuous weighing means (39) for continuously weighing said semifinished product (S) and dosing means (38) for metered addition of said nutritional additives (A) to said amalgamated semifinished product (S), said dosing means (38) being located upstream from said forming means (13) to change the mixed amount (D₂) of said nutritional additives (A) according to the instantaneous weight detected by said weighing means (39).

13. A method of manufacturing long-fiber feed pellets (C) for zootechnical use using a plant as claimed in claim 1, comprising the steps of:
a) selecting various types of hays (F, F′) obtained from legumes and grass;
b) mixing predetermined amounts of said hay types (F, F′) to obtain a fibrous mixture;
c) cutting said fibrous mixture to obtain a long-fiber forage base;
d) adding a predetermined amount of one or more binders (L) to said forage base;
e) mixing said forage base with said one or more binders (L) to obtain a semifinished product (S);
f) adding one or more nutritional additives (A) to said semifinished product (S);
g) mixing said one or more nutritional additives (A) with said semifinished product (S) to obtain a dough (I);
h) forming said dough (I) into predeterminedly shaped feed pellets (C) for consumption by the animal; and
i) packaging said feed pellets (C);
further comprising, upstream of said forming step h), a step j) of automatic adjusting the moisture content of said dough (I) to improve its processability by changing the amount of binders (L) added thereto, and wherein said forming step h) comprises of extruding said dough (I) through at least one passage (16) located peripherally of a substantially annular gap (17), said extrusion being obtained by rotating a disk-shaped pusher element (25) which is rotatably and eccentrically mounted in said gap (17) to radially push said dough (I) outwards, and form successive layers (H), wherein the successive layers form at least one bead (B) which interacts with the walls (31) of breaking means (30) located at the output of said passages (16) to form wafer-shaped feed pellets (F) that are easily chewed and crumbled by the animal.

14. The method as claimed in claim 13, wherein said adjustment step j) is adapted to maintain the moisture content of said dough (I) in a range from 5% to 40% based on its total weight.

15. The method as claimed in claim 13, further comprising a step k) of sanitizing said pellets (C) to reduce bacterial and sporal load, and molds and yeasts, and thus increase shelf-life of the feed.

16. The method as claimed in claim 15, wherein said sanitizing step k) is carried out through a step l) of applying an electromagnetic field having a predetermined frequency to said pellets (C), followed by a first cooling step m) for cooling said pellets (C).

17. The method as claimed in claim 16, wherein said electromagnetic field has a radio-frequency or microwave spectrum frequency.

18. The method as claimed in claim 13, wherein said cutting step c) is adapted to obtain a forage base with fibers having an average length from 3 cm to 10 cm.

19. The method as claimed in claim 13, further comprising a step n) of weighing said semifinished product (S), said adding step f) being designed such that the amount of said one or more nutritional additives (A) added to said semifinished product (S) changes according to the weight of said semifinished product (S) as detected in said weighing step n).

20. The method as claimed in claim 15, further comprising, before the sanitizing step k), a second cooling step o) for cooling said pellets (C).

21. The method as claimed in claim 13, wherein said binders (L) are sugar-based aqueous molasses.

22. The method as claimed in claim 13, wherein, in said step d), the total weight percent of said one or more binders (L) that are added ranges from 3% to 17% based on the total weight of the dough (I).

23. The method as claimed in claim 13, wherein, in said step b), mixing amounts are 5% to 50% legume hay types (F), based on the total weight and 50% to 95% grass hat types (F′), based on the total weight.

24. The method as claimed in claim 13, wherein, in said step f), nutritional additives (A) selected from the group consisting of vitamins, mineral salts, or cereals are added.

25. The method as claimed in claim 13, wherein said pellets (C) are formed with plan shapes selected from the group consisting of square, rectangular, polygonal, circular, or elliptical shapes.
